(19) United States
(12) Patent Application Publication
(10) Pub. No.: US 2015/0088701 A1
(43) Pub. Date: Mar. 26, 2015

(54) SYSTEM AND METHOD FOR IMPROVED PLANOGRAM GENERATION

(71) Applicants: Daniel Norwood Desmarais, Toronto (CA); Brandon Michael Wolf, Moseley, VA (US); David Harris Hunter, Burlington (CA); Lawrence George Ellerton, Toronto (CA)

(72) Inventors: Daniel Norwood Desmarais, Toronto (CA); Brandon Michael Wolf, Moseley, VA (US); David Harris Hunter, Burlington (CA); Lawrence George Ellerton, Toronto (CA)

(21) Appl. No.: 14/034,093

(22) Filed: Sep. 23, 2013

(51) Int. Cl. G06Q 10/08

(52) U.S. Cl. CPC G06Q 10/087
USPC 705/28

(57) ABSTRACT

Various embodiments are described herein for methods and systems that can be used for generating a planogram data file by: receiving, at a remote computing device, recorded position data for one or more items located on first and second fixtures of a display segment, and generating, using the remote computing device, a planogram data file. The planogram data file may be generated by: writing product data for the one or more items, and fixture location data for the first fixture; writing, based on the recorded position data, position data for the items located on the first fixture to the planogram data file, determining a first maximum item height for the one or more items on the first fixture, and writing, based on the first maximum item height, fixture location data for the second fixture to the planogram data file.

### FIELD

The described embodiments relate to methods and systems for generating planograms, and more particularly to methods and systems for generating a planogram data file at a remote computing device.

### BACKGROUND

Planograms (also known as plan-o-grams, POGs, and schematics) are diagrams or models that indicate the placement of items on one or more fixtures of a storage or display segment, such as a shelving unit. A planogram may specify which products (and in what quantity) are to be placed on a given shelving unit, and a location on the shelving unit for each of these products.

Retail store operators may use planograms in an effort to provide a standardized shelf layout, so that displays in multiple stores have the same ‘look and feel’ to customers. A product manufacturer (e.g. a consumer packaged goods manufacturer) may provide a planogram to retailers when (or before) providing a new product, in order to show how the product relates to existing products, and/or how the product should be displayed on a display segment.

### SUMMARY

In one broad aspect, in at least one embodiment described herein, there is provided a method for generating a planogram data file, the method comprising: receiving, at a remote computing device, first recorded position data for one or more first items located on a first fixture of a display segment, and second recorded position data for one or more second items located on a second fixture of the display segment; generating, using the remote computing device, a planogram data file, by: writing first item data for the one or more first items and second item data for the one or more second items to the planogram data file; writing fixture location data for the first fixture to the planogram data file; writing, based on the first recorded position data, first position data for the one or more first items to the planogram data file; determining, based on the first item data, a first maximum item height for the one or more first items; writing, based on the first maximum item height, fixture location data for the second fixture to the planogram data file; and writing, based on the second recorded position data, second position data for the one or more second items to the planogram data file.

In some embodiments, the first recorded position data and the second recorded position data is received from a mobile communication device that recorded the first recorded position data and the second recorded position data.

In some embodiments, recording the first recorded position data and the second recorded position data comprises: scanning, using a scanner operatively coupled to the mobile communication device, one or more first identifiers associated with at least one of the one or more first items, providing an indication that position data has been recorded for the first fixture, and scanning, using the scanner, one or more second identifiers associated with at least one of the one or more second items.

In at least some of the embodiments, the scanner may be a barcode scanner and the identifiers may be barcodes.

Alternatively, in at least some of the embodiments, the scanner may be a camera and the identifiers may be an image or a barcode of the one or more items.

Alternatively, in at least some of the embodiments, recording the first recorded position data and the second recorded position data comprises: recording, using a camera operatively coupled to the mobile communication device, one or more first barcodes or first images associated with at least one of the one or more first items, providing an indication that position data has been recorded for the first fixture, and recording, using the camera, one or more second barcodes or second images associated with at least one of the one or more second items.

In some embodiments, the method further comprises: receiving, at the remote computing device, a library of item data; and storing the library of item data in a database accessible to the remote computing device, wherein the first item data and the second item data is based on the library of item data.

In some embodiments, the method further comprises: receiving, at the mobile communication device, at least a subset of the library of item data prior to recording the first recorded position data and the second recorded position data.

In some embodiments, the method further comprises: receiving, at the remote computing device, a library of fixture data; and storing the library of fixture data in a database accessible to the remote computing device, wherein the fixture data is based on the library of fixture data.

In some embodiments, the method further comprises: receiving, at the mobile communication device, at least a subset of the library of fixture data prior to recording the first recorded position data and the second recorded position data.

In some embodiments, the method further comprises: receiving, at the remote computing device, a template planogram; and storing the template planogram in a database accessible to the remote computing device, wherein at least one of the first item data, the second item data, and the fixture data is based on data extracted from the template planogram.

In some embodiments, determining the first maximum item height comprises: for each of the one or more first items: determining an estimated item height for that item based on: one or more of a height, a width, and a depth of that item; and one or more of an item orientation, an item merchandise style, and an item stacking indicator for that item; and selecting the largest estimated item height as the first maximum item height.

In some embodiments, at least one of the height, width, depth, item orientation, item merchandise style, and item stacking indicator for each of the one or more first items is based on data extracted from a template planogram stored in a database accessible to the remote computing device.

In some embodiments, a height component of the second position data is determined based on a height component of the first position data, the first maximum item height, and a predetermined height adjustment.

In at least some of these embodiments, the predetermined height adjustment may be a predetermined finger space adjustment.

In another broad aspect, in at least one embodiment described herein, there is provided a system for generating a planogram data file, the system comprising: a processor; and a data store coupled to the processor, wherein the processor is configured to: receive first recorded position data for one or more first items located on a first fixture of a display segment, and second recorded position data for one or more second items located on a second fixture of the display segment; generate a planogram data file, by: writing first item data for the one or more first items and second item data for the one or more second items to the planogram data file; writing fixture location data for the first fixture to the planogram data file; writing, based on the first recorded position data, first position data for the one or more first items to the planogram data file; determining, based on the first item data, a first maximum item height for the one or more first items; writing, based on the first maximum item height, fixture location data for the second fixture to the planogram data file; and writing, based on the second recorded position data, second position data for the one or more second items to the planogram data file.

In some embodiments, the first recorded position data and the second recorded position data is received from a mobile communication device that recorded the first recorded position data and the second recorded position data.

In some embodiments, recording the first recorded position data and the second recorded position data comprises: scanning, using a scanner operatively coupled to the mobile communication device, one or more first identifiers associated with at least one of the one or more first items, providing an indication that position data has been recorded for the first fixture, and scanning, using the scanner, one or more second identifiers associated with at least one of the one or more second items.

In at least some of the embodiments, the scanner may be a barcode scanner and the identifiers may be barcodes.

Alternatively, in at least some of the embodiments, the scanner may be a camera and the identifiers may be an image or a barcode of the one or more items.

Alternatively, in at least some of the embodiments, recording the first recorded position data and the second recorded position data comprises: recording, using a camera operatively coupled to the mobile communication device, one or more first barcodes or first images associated with at least one of the one or more first items, providing an indication that position data has been recorded for the first fixture, and recording, using the camera, one or more second barcodes or second images associated with at least one of the one or more second items.

In some embodiments, the first item data and the second item data is based on a library of item data stored in the data store.

In some embodiments, the fixture data is based on a library of fixture data stored in the data store.

In some embodiments, at least one of the first item data, the second item data, and the fixture data is based on data extracted from a template planogram stored in the data store.

In some embodiments, the processor is configured to determine the first maximum item height by: for each of the one or more first items: determining an estimated item height for that item based on: one or more of a height, a width, and a depth of that item; and one or more of an item orientation, an item merchandise style, and an item stacking indicator for that item; and selecting the largest estimated item height as the first maximum item height.

In some embodiments, at least one of the height, width, depth, item orientation, item merchandise style, and item stacking indicator for each of the one or more first items is based on data extracted from a template planogram stored in the data store.

In some embodiments, the processor is configured to determine a height component of the second position data based on a height component of the first position data, the first maximum item height, and a predetermined height adjustment.

In at least some of these embodiments, the predetermined height adjustment may be a predetermined finger space adjustment.

In another broad aspect, in at least one embodiment described herein, there is provided a computer-readable medium storing computer-executable instructions, the instructions for causing a processor to perform a method for generating a planogram data file, the method comprising: receiving first recorded position data for one or more first items located on a first fixture of a display segment, and second recorded position data for one or more second items located on a second fixture of the display segment; generating a planogram data file, by: writing first item data for the one or more first items and second item data for the one or more second items to the planogram data file; writing fixture location data for the first fixture to the planogram data file; writing, based on the first recorded position data, first position data for the one or more first items to the planogram data file; determining, based on the first item data, a first maximum item height for the one or more first items; writing, based on the first maximum item height, fixture location data for the second fixture to the planogram data file; and writing, based on the second recorded position data, second position data for the one or more second items to the planogram data file.

In some embodiments, the first item data and the second item data is based on a library of item data stored in a database accessible to the processor.

In some embodiments, the fixture data is based on a library of fixture data stored in a database accessible to the processor.

In some embodiments, at least one of the first item data, the second item data, and the fixture data is based on data extracted from a template planogram stored in a database accessible to the processor.

In some embodiments, determining the first maximum item height comprises: for each of the one or more first items: determining an estimated item height for that item based on: one or more of a height, a width, and a depth of that item; and one or more of an item orientation, an item merchandise style, and an item stacking indicator for that item; and selecting the largest estimated item height as the first maximum item height.

In some embodiments, at least one of the height, width, depth, item orientation, item merchandise style, and item stacking indicator for each of the one or more first items is based on data extracted from a template planogram stored in a database accessible to the processor.

In some embodiments, a height component of the second position data is determined based on a height component of the first position data, the first maximum item height, and a predetermined height adjustment.

In at least some of these embodiments, the predetermined height adjustment may be a predetermined finger space adjustment.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment and the figures will now be briefly described.

FIG. 1 is an example of a planogram;

FIG. 2 is another example of a planogram;

FIG. 3 is a block diagram of a system for generating a planogram data file in accordance with at least one embodiment;

FIG. 4 is a flow diagram illustrating a sequence of events for generating a planogram data file, in accordance with at least one embodiment;

FIG. 5 is a flow diagram illustrating a sequence of events for recording position date using a mobile communication device, in accordance with at least one embodiment;

FIGS. 6a-g are examples of a user interface of a mobile communication device, in accordance with at least one embodiment;

FIG. 7 is a block diagram of a computing device in accordance with at least one embodiment;

FIG. 8 is a block diagram of a mobile computing device in accordance with at least one embodiment; and

FIG. 9 is another example of a planogram with a jump shelf.

Further aspects and features of the embodiments described herein will appear from the following description taken together with the accompanying drawings.

### DESCRIPTION OF EXAMPLE EMBODIMENTS

Various apparatuses or processes will be described below to provide an example of at least one embodiment of the claimed subject matter. No embodiment described below limits any claimed subject matter and any claimed subject matter may cover processes, apparatuses, devices, or systems that differ from those described below. The claimed subject matter is not limited to apparatuses, devices, systems, or processes having all of the features of any one apparatus, device, system, or process described below or to features common to multiple or all of the apparatuses, devices, systems, or processes described below. It is possible that an apparatus, device, system, or process described below is not an embodiment of any claimed subject matter. Any subject matter that is disclosed in an apparatus, device, system, or process described below that is not claimed in this document may be the subject matter of another protective instrument, for example, a continuing patent application, and the applicants, inventors, or owners do not intend to abandon, disclaim, or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should also be noted that the terms “coupled” or “coupling” as used herein can have several different meanings depending in the context in which the term is used. For example, the term coupling can have a mechanical or electrical connotation. For example, as used herein, the terms “coupled” or “coupling” can indicate that two elements or devices can be directly connected to one another or connected to one another through one or more intermediate elements or devices via an electrical element, electrical signal or a mechanical element such as but not limited to, a wire or a cable, for example, depending on the particular context.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The various embodiments of the methods, systems, and devices described herein may be implemented using a combination of hardware and software. These embodiments may be implemented in part using computer programs executing on programmable devices, each programmable device including at least one processor, an operating system, one or more data stores (including volatile memory or non-volatile memory or other data storage elements or a combination thereof), at least one communication interface and any other associated hardware and software that is necessary to implement the functionality of at least one of the embodiments described herein. For example, and without limitation, the computing device may be a server, a network appliance, an embedded device, a computer expansion module, a personal computer, a laptop, a personal data assistant, a cellular telephone, a smart-phone device, a tablet computer, a wireless device, or any other computing device capable of being configured to carry out the methods described herein. The particular embodiment depends on the application of the computing device.

In some embodiments, the communication interface may be a network communication interface, a USB connection, or another suitable connection as is known by those skilled in the art. In other embodiments, the communication interface may be a software communication interface, such as those for inter-process communication (IPC). In still other embodiments, there may be a combination of communication interfaces implemented as hardware, software, and a combination thereof.

In at least some of the embodiments described herein, program code may be applied to input data to perform at least some of the functions described herein and to generate output information. The output information may be applied to one or more output devices, for display or for further processing.

At least some of the embodiments described herein that use programs may be implemented in a high level procedural or object oriented programming and/or scripting language or both. Accordingly, the program code may be written in C, Java, SQL or any other suitable programming language and may comprise modules or classes, as is known to those skilled in object oriented programming. However, other programs may be implemented in assembly, machine language or firmware as needed. In either case, the language may be a compiled or interpreted language.

The computer programs may be stored on a storage media (e.g. a computer readable medium such as, but not limited to, ROM, magnetic disk, optical disc) or a device that is readable by a general or special purpose computing device. The program code, when read by the computing device, configures the computing device to operate in a new, specific and predefined manner in order to perform at least one of the methods described herein.

Furthermore, some of the programs associated with the system, processes, and methods of the embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The various embodiments disclosed herein generally relate to generating planograms, and more particularly, to methods and systems for generating a planogram data file at a remote computing device in a more efficient manner. A planogram data file is a collection of information that defines where products are placed in a retail store. For example, the planogram data file may define the shelf or fixture where a given product is placed as well as the quantity of the given product. Planogram data files generated using the various embodiments disclosed herein may be accessed and/or modified using specialized planograming software, such as JDA Software Group, Inc.'s Space Planning software, for example.

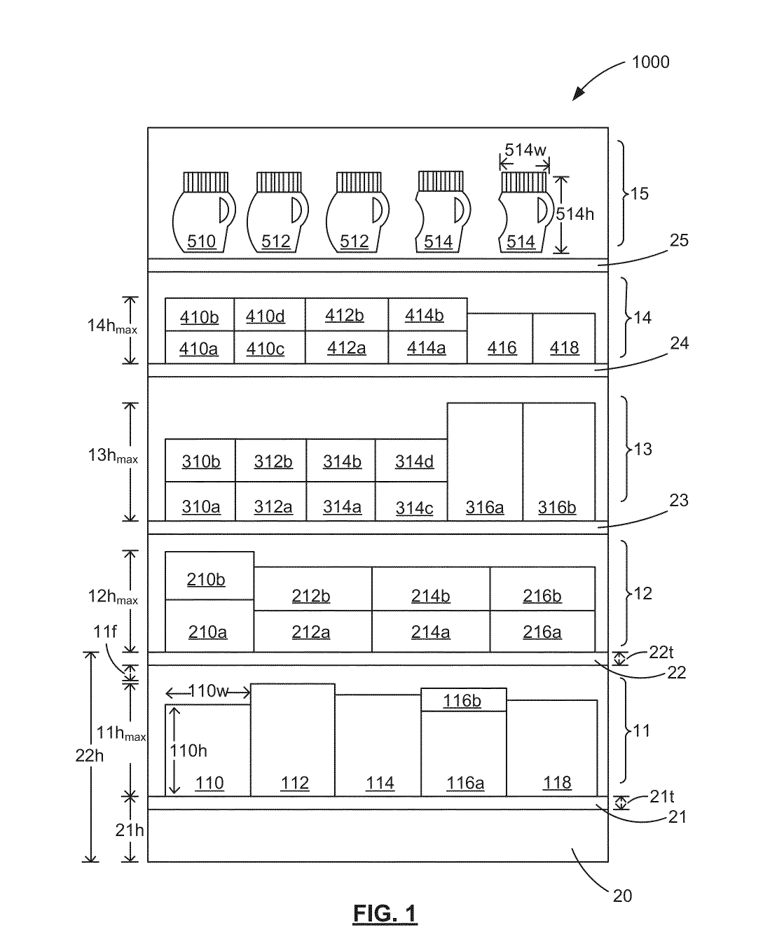

Reference is now made to FIG. 1, which illustrates an example of a planogram 1000. The illustrated planogram depicts a display segment 20 having first, second, third, fourth, and fifth shelves (also referred to as fixtures) 21, 22, 23, 24, and 25 upon which first, second, third, fourth, and fifth rows of items 11, 12, 13, 14, and 15 are supported. In general, fixtures are elements that can be used to display one or more items and a display segment may comprise one or more fixtures.

The first row of items 11 includes items 110, 112, 114, 116, and 118. The items in this first row 11 are shown on first fixture 21, which in this example is the lowest shelf of segment 20. Each item depicted in the planogram may be a unique product, or a unique stock-keeping unit (SKU), which can be a distinct size, style, colour, and/or packaged quantity of a product. In general, items are products that are put on display for sale.

For example, items 110, 112, 114, 116, and 118 may each be boxes of cereal, with items 110, 112, being different types of a particular brand of shredded wheat cereal (e.g. plain, frosted, and fruit-filled), while items 116 and 118 may be different types of cereal (e.g. crisped rice and toasted flaked corn). In other embodiments, other types of products may be on the first shelf 21.

While items 110, 112, 114, and 118 are shown with the units of each item in the same orientation, a unit 116b of item 116 is shown as being placed in a different orientation than unit 116a. If one or more units of an item are placed on a fixture in one orientation (e.g. a ‘front’ orientation), and one or more additional units are placed on top of these units in another orientation (e.g. a ‘top’ orientation), this may be referred to as a ‘top cap’.

The second row of items 12 includes items 210, 212, 214, and 216. As shown, more than one unit of each of items 210, 212, 214, and 216 is visible in the planogram, as items 210, 212, 214, and 216 are each shown as being stacked two units high. For example, a first unit of item 210 (labeled as 210a) is shown resting on second fixture (shelf) 22, and a second unit of item 210 (labeled as 210b) is shown resting on unit 210a.

The third row of items 13 includes items 310, 312, 314, and 316. In this row, items 310 and 312 are each shown as being stacked two units high on shelf 23. Item 314 is shown as being stacked two units high (e.g. units 314a and 314b), and also arranged two units wide (e.g. units 314a and 314c). Item 316 is also shown as being arranged two units wide (e.g. 316a and 316b).

Where multiple units of an item are shown in a planogram, typically each stack of one or more units of an item is referred to collectively as a facing. For example, in the third row of items 13, there is one facing of item 310, one facing of item 312, two facings of item 314, and two facings of item 316.

The fourth row of items 14 includes items 410, 412, 414, 416, and 418. As illustrated, on shelf 24 there are two facings of item 410, and one facing of each of items 412, 414, 416, and 418.

The fifth row of items 15 includes items 510, 512, and 514, with two facings of each item shown on fifth shelf 51, which in this example is the highest shelf of display segment 20. It should be noted that in FIG. 1, the height of an item is indicated by an h added to a reference numeral and the width is indicated by a w added to a reference numeral such as 514h and 514w, respectively, for item 514.

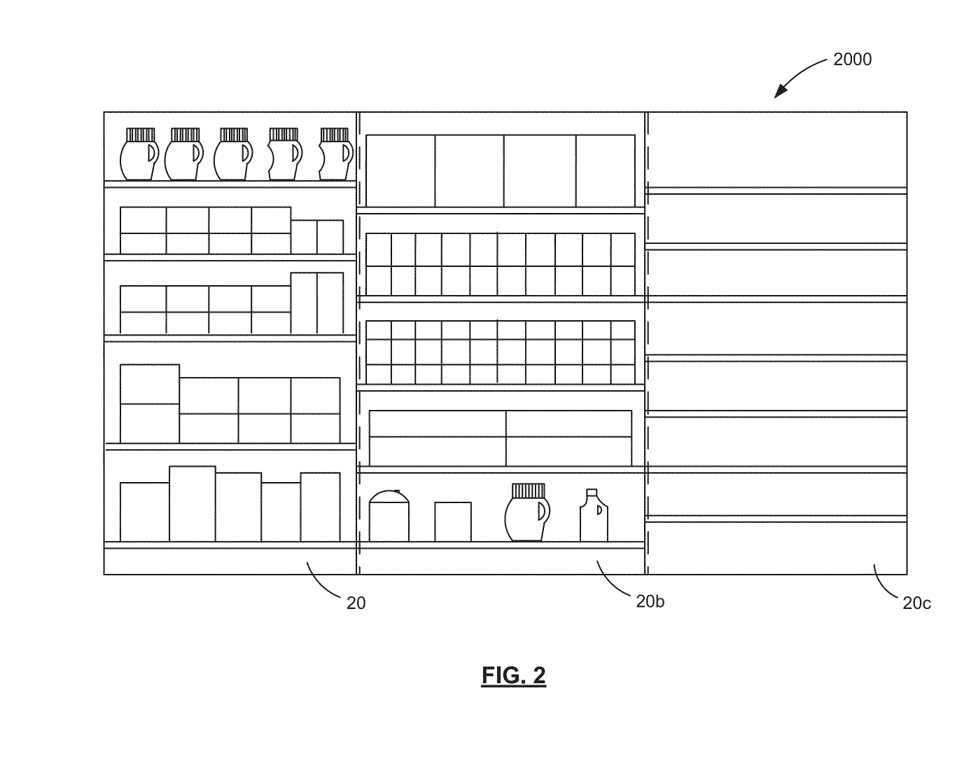

While the planogram of FIG. 1 depicts a single display segment 20, planograms can also depict more than one segment, and each segment may have different configurations of fixtures. For example, FIG. 2 illustrates an example planogram 2000 that includes the depiction of segment 20 shown in planogram 1000, as well as segments 20b and 20c. Display segments 20, 20b, and 20c can be separately shelved segments of a discreet physical shelving unit, or adjacently arranged (but physically separate) shelving units. As can be seen in the example of FIG. 2, each of the display segments 20, 20b and 20c have a different arrangement of heights, and number of fixtures (e.g. shelves). It will be appreciated that other display segment and/or fixture arrangements are also possible.

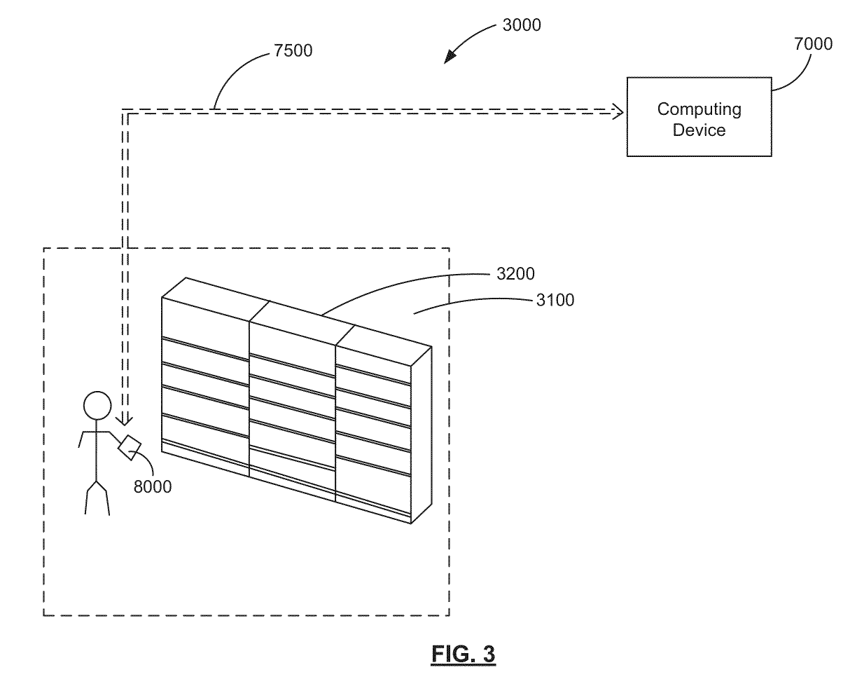

As shown in FIG. 3, a system 3000 for generating a planogram data file in accordance with at least one embodiment of the teachings herein includes a mobile communication device 8000, operable to communicate with a remote computing device 7000 over a communication channel 7500, which can be a wireless communication channel. The remote computing device 7000 may be a server or some other computing device that is capable of providing the functionality of the remote computing device 7000 and the various associated methods described herein. System 3000 allows a user to record position data for one or more items located on one or more display segments 3200 in a store 3100, using mobile communication device 8000, and transmit the recorded position data to remote computing device 7000, where a planogram data file can be generated. This operation may be repeated for a number of display segments throughout the store. This operation may also be repeated for a number of stores.

Previously, a conventional technique for generating a planogram data file involved bringing a computing device (e.g. a laptop) on which a full version of specialized space management software was installed, and on which a full product library was loaded, to a display segment in a store, and then entering data directly into the space management software. While in some instances the entry of item data was at least somewhat automated (e.g. by using an external barcode scanner connected to the laptop to read in Universal Product Code (UPC) codes), correct usage of the specialized space management software often required at least two days of training as well as the user having to manually hit certain keys on the laptop in order to indicate various information such as, but not limited to, scanning the end of a shelf (e.g., fixture), the number of items of a given type on a shelf, and the dimensions for the shelves in the display segment. Furthermore, the specialized space management software on the laptop builds the entire planogram data file which is then transferred to other users and systems.

Advantageously, methods described in the present application, by facilitating data collection through a mobile communication device and generating a planogram data file using a remote computing device that operates in a more intelligent manner, may allow users without extensive training or experience with specialized space management software to generate planograms as well as to generate the planograms much faster and in a less tedious fashion as compared to previous conventional techniques.

A user of system 3000 will initially initiate transmission of a library of item data, a library of fixture data, and/or one or more template planograms to remote computing device 7000. For example, data can be transmitted as part of registering an account with an entity that provides services using remote computing device 7000. Remote computing device 7000 is configured to store the received library of item data, library of fixture data, and/or the template planogram (or planograms) in a database accessible to the remote computing device. It will be appreciated that the library of item data, library of fixture data, and/or the template planogram(s) can be updated from time to time.

The received library of item data may include information regarding a plurality of items. For example, information for each item may include a UPC code, a name for the item (e.g. “Mint toothpaste”), dimensions for the item (e.g. height, width, depth), pricing information (e.g. a manufacturer's suggested retail price), size information (e.g. a volume and/or mass of the item), country of origin of the item, one or more images of the item, etc.

The received library of fixture data may include information regarding one or more fixtures, or fixture types. For example, information for each fixture may include dimensions for the fixture (e.g. height, width, and depth), and may include a common name for the fixture (e.g. “Gondola 48-78”).

A received template planogram may include some or all of the item data in the library of item data, and/or may include some or all of the fixture data in the library of fixture data. A received template planogram may include information regarding the above data as well as merchandising information related to how the items are placed on a fixture, such as orientation information and/or merchandise style information, as will be discussed subsequently.

As will be discussed further below, data extracted from one or more of the library of item data, library of fixture data, and the one or more template planograms can be used when recording position data for one or more items, and for generating a planogram data file.

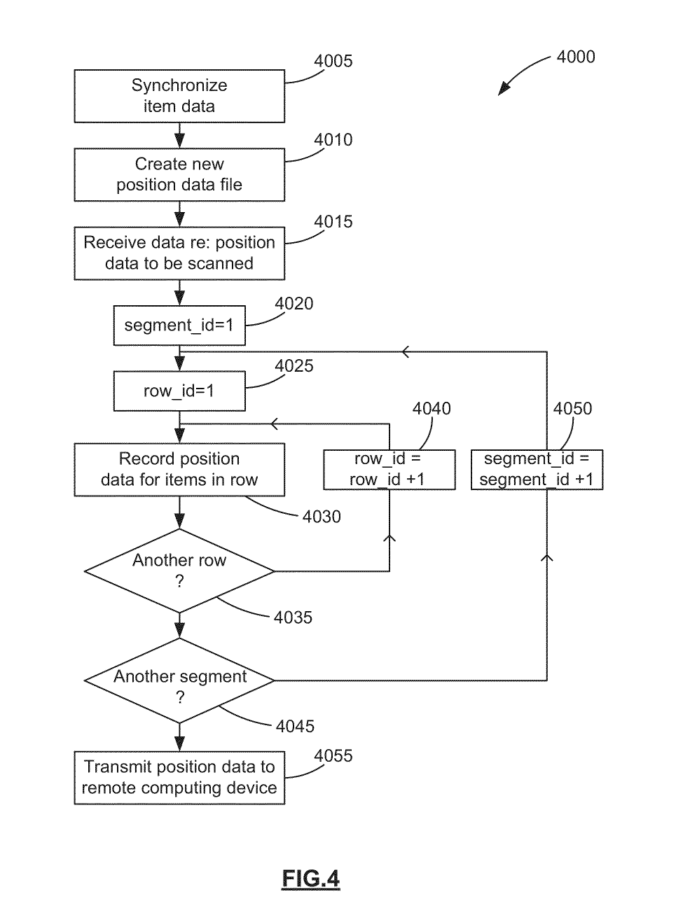

An example embodiment for a method for recording position data will now be described with reference to FIG. 4, and is shown generally as 4000.

At 4005, data is optionally synchronized between mobile communication device 8000 and remote computing device 7000. For example, at least a subset of the library of item data stored in a database accessible to the remote computing device 7000, and/or item data extracted from one or more template planograms may be transferred to mobile communication device 8000 prior to recording position data. This item data may be used, for example, to populate one or more menus of item data presented in a user interface of mobile communication device 8000, which may facilitate the collection of position data for these items.

For example, item data information for each item may include a UPC code, a name for the item, a height, width, and depth for the item, pricing information for the item, size information for the item, and/or country of origin of the item.

Alternatively, or additionally, item data transferred to mobile communication device 8000 may include orientation information (e.g. which side of a unit of a given item is to be presented to a customer). From a marketing perspective, it may be preferable to orient units of an item on a fixture so that the largest presentable surface area faces a customer, which may be referred to as a “front” orientation. For instance, where the item is a relatively large and generally rectangular package of dog food, the large rectangular face with e.g. the product name and/or a picture of a healthy, happy dog would be considered the “front” of the item. But typically, such an item would not be placed on a fixture with the “front” facing outward from display segment. Instead, such an item would typically be placed on a lower shelf with the large rectangular face facing up, with the “front” facing upward and the bottom of the item facing outward from display segment; this orientation may be considered either a “top” or a “bottom” orientation.

Orientation information transferred to mobile communication device 8000 may be used to pre-populate orientation information to be recorded while recording position data for an item. For example, when an identifier (e.g. a UPC code) is entered for an item, data regarding an expected orientation may be presented to a user of mobile communication device 8000 as an initial entry, although a user may change the initial entry based on the observed orientation of the item on a fixture.

Item data transferred to mobile communication device 8000 may also include merchandise style information. Merchandise style refers to the manner in which the item is grouped on the fixture. A “unit” merchandise style indicates that separate units of the item are placed on the shelf with no other packaging involved. A ‘tray’ merchandise style indicates that separate units of the item are organized in a container that keeps the units together, but units of the item may be removed from the fixture and/or sold individually. A “case” merchandise style indicates that separate units of the item are grouped together in a closed container and are intended to be removed from the fixture and/or to be sold as a group. In some instances, a “case” may be opened on the fixture, allowing individual units of the item to be removed from the case and sold separately.

Merchandise style information transferred to mobile communication device 8000 may be used to pre-populate merchandise style information to be recorded while recording position data for an item. For example, when an identifier (e.g. a UPC code) is entered for an item, data regarding an expected merchandise style may be presented to a user of mobile communication device 8000 as an initial entry, although a user may change the initial entry based on the observed merchandise style of the item on a fixture.

Other data transferred to mobile communication device 8000 may also include division information and category information, which may be extracted from one or more template planograms.

Division information (which may also be referred to as banner or channel information) may indicate one or more divisions which may be used to group, sort, and/or search generated planogram data files. For example, division information may include “Grocery”, “Drug”, “Fashion”, “Retailer_{—}1”, “Retailer_{—}2”, “Discount”, “Conventional”, etc.

Division information transferred to mobile communication device 8000 may be used to pre-populate division information to be included in a position data file (as will be discussed further below). For example, when creating a new position data file, data regarding expected division identifiers may be presented to a user of mobile communication device 8000 in a drop-down list.

Category information may indicate one or more item categories which may be used to group, sort, and/or search generated planogram data files. For example, category information may be used in the file name of a generated planogram data file (e.g. <Store>+“ ”+<Category>.psa)

Category information transferred to mobile communication device 8000 may be used to pre-populate category information to be included in a position data file (as will be discussed further below). For example, when creating a new position data file, data regarding expected categories (e.g. “Toothpaste”, “Oral care”, “Deodorant”, “Cereal”, etc.) may be presented to a user of mobile communication device 8000 in a drop-down list.

Other data transferred to mobile communication device 8000 may also include company information specific to a user and/or an organization that has an account with an entity that provides services using remote computing device 7000. For example, company information may include customized default values for one or more data fields (e.g. data for unknown items), and/or settings that modify the functionality of mobile communication device 8000 (e.g. disabling an ability to capture photographs in a ‘notes’ field, as will be discussed further below).

In some embodiments, at least a subset of the library of fixture data stored in a database accessible to the remote computing device 7000 can be transferred to mobile communication device 8000 prior to recording position data. Fixture data transferred to mobile communication device 8000 may include a name, and/or height, width, and depth information for one or more fixtures or fixture types. This fixture data can be used, for example, to populate one or more menus of fixture data presented in a user interface of mobile communication device 8000.

At 4010, a new position data file for a planogram to be generated is created at mobile communication device 8000. This file is modified as a user records position data for one or more items. The user can indicate when position data for all of the items on one fixture (e.g. a shelf) have been recorded and position data for items on another shelf is to be recorded. The user can also indicate when all of the items on the current display segment have been scanned and indicate that one or more items on another display segment are to be scanned.

At 4015, data regarding the planogram to be generated is received at remote computing device 7000, e.g. via a user interface of mobile communication device 8000. Data regarding the planogram to be generated can include store identification information (e.g. a store name, a store address, a store identifier number), division and/or category information, position information, (e.g. orientation information, merchandise style information, facing information), fixture information (e.g. an indication of a standard display segment type, a fixture type identification number, fixture dimensions), an indication of a number of display segments for which position data will be recorded, and other notes or information regarding the planogram to be generated. This data regarding the planogram to be generated in general may be any alpha-numeric combination. The user may first attempt to select a suitable entry from a scrolling list of choices for a given type of information that is provided by the user interface of mobile communication device 800 before manually entering any values as this produces results requiring less manual intervention which also results in faster scanning and less potential for data entry errors.

At 4020, a segment_id counter can be set (or reset) to 1, and at 4025, a row_id counter for the segment can be set (or reset) to 1. The purpose for these counters will be discussed further below.

At 4030, position data for one or more items on (or intended to be on) the current shelf is recorded using mobile communication device 8000. Preferably, position data is collected for each item by scanning a barcode or other symbol or identifier associated with a unit of the item using a scanner associated with mobile communication device 8000. For example, each unit of an item may be labeled with a unique identifier, such as a UPC barcode, an International Article Number (EAN or EAN-13) barcode, and/or a Global Trade Item Number (GTIN). Alternatively, or additionally, a barcode or other symbol associated with the item may be provided on the fixture (e.g. on a front face of the shelf on which units of the item are (or are intended to be) resting. This may allow position data to be collected for an item even if no units of that item are currently on the fixture (e.g. where an item is out of stock at the time the position data is recorded).

Alternatively, or additionally, mobile communication device 8000 can allow position data for an item to be recorded using a camera of the mobile communication device 8000. Preferably, program logic resident on mobile communication device 8000 is configured to process an image of a barcode (e.g. a 2d or 3d barcode) or other symbol or identifier captured with the camera to decode the barcode, symbol or identifier and extract a unique item identifier.

Alternatively, or additionally, mobile communication device 8000 can allow position data for an item to be input via a user interface of the mobile communication device 8000. For example, a user may be able to manually input a UPC code or other item identifier to mobile communication device 8000. This may be useful, for example, where the scanner associated with mobile communication device 8000 is unable to correctly capture barcode information for a particular item. This may occur, for example, if a barcode or symbol provided on a fixture is dirty or scratched. Also, some item packaging may be difficult to scan (e.g. clear bottles or packaging that is highly reflective). Manual input may also be useful if the scanner and/or camera associated with mobile communication device 8000 is not functioning correctly.

Position data recorded for an item can also include a number of facings of that item present on the fixture (e.g. shelf). The number of facings for an item can be recorded by sequentially scanning multiple instances of a unique identifier associated with an item. For example, if two facings of an item are present on a shelf, a user may scan a UPC code associated with that item twice. Alternatively, the number of facings for an item can be recorded via the user interface of mobile communication device 8000. For example, if two facings of an item are present on the shelf, a user may scan one instance of a UPC code associated with that item, and then enter or modify a total number of facings for that item via the user interface of mobile communication device 8000.

Position data recorded for an item can also include a quantity of units of that item present on the fixture. The quantity of units for an item can be recorded via the user interface of mobile communication device 8000. For example, if nine units of an item are present on a shelf, a user may enter a quantity of nine for that item via the user interface of mobile communication device 8000. A default value of −1 may be used to indicate that the quantity of units was not reviewed by the user.

Position data recorded for an item can also include orientation information (e.g. front/side/top), a “units high” value indicating how many units of an item were stacked on top of each other on the fixture, and/or merchandise style information (e.g. unit/tray/case).

Once position data has been recorded for each item in the current row (e.g. for each item on a particular fixture, such as a shelf), at 4035 a user can provide an indication to mobile communication device 8000 as to whether or not there are more rows of items for which position data is to be recorded. For example, a user may select a “next shelf” icon displayed on the user interface of mobile communication device 8000. If there are more rows of items for which position data is to be recorded (e.g. if there are more fixtures in a display segment for which position data is to be recorded), at 4040 the row_id counter can be incremented by one, and the method 4000 returns to 4030, where position data for the next row of items is recorded using mobile communication device 8000.

Preferably, position data for items on the lowest fixture (e.g. shelf) of a display segment is recorded first, followed by recording position data for items on the second-lowest fixture, and so on. While the examples discussed herein follow this ‘bottom-up’ approach, it will be appreciated that a lop-down′ approach may also be possible.

If at 4035 there are no more rows of items for which position data is to be recorded, the method 4000 proceeds to 4045, where a user can provide an indication to mobile communication device 8000 as to whether or not there are more display segments for which position data is to be recorded. For example, a user may select a “next segment” icon displayed in the user interface of mobile communication device 8000. If there are more display segments for which position data is to be recorded, at 4050 the segment_id counter can be incremented by one, and the method 4000 returns to 4025, where the row_id counter for the segment can be set (or reset) to 1, and position data for the next row of items is recorded at 4030 using mobile communication device 8000.

If no indication is provided at 4045 that there are more display segments for which position data is to be recorded, the position data file can be saved at mobile communication device 8000, and at 4055 a copy of the position data file can be transmitted to remote computing device 7000.

While in the above examples position data was recorded in a left-to-right order, it will be appreciated that the position data may alternatively be recorded in right-to-left order. It will also be appreciated that the row_id and segment_id counters were described to illustrate the progression of the method 4000, and that position data may be recorded without the use of such counters.

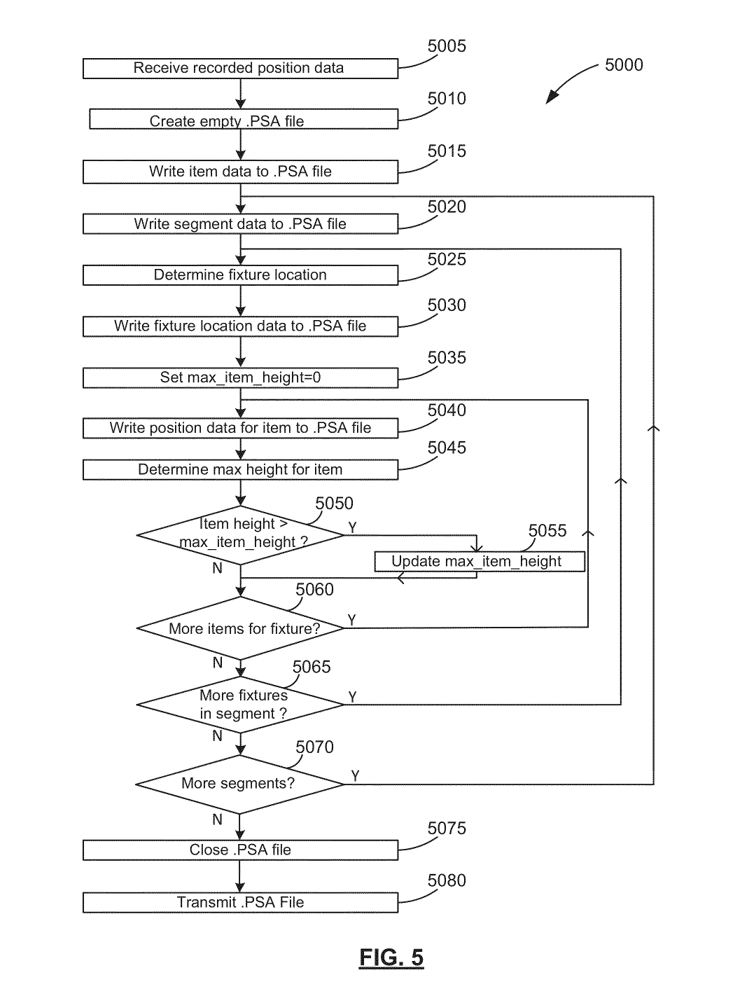

An example method for generating a planogram data file will now be described with reference to FIG. 5, and is shown generally as 5000. Some of the details of method 5000 have been previously described herein, and the reader is directed to earlier parts of the description for further details.

At 5005, recorded position data is received at a remote computing device 7000. As discussed above, the recorded position data may be received from a mobile communication device 8000.

At 5010, the remote computing device 7000 generates an ‘empty’ planogram data file, such as a comma separated value (CSV) file compatible with the .psa file format.

It will be appreciated that in some embodiments, the generation of the empty .psa file may precede the receipt of the recorded position data.

At 5015, the empty .psa file created at 5010 is populated with item data. Item data for an item includes, for example, a height of the item, a width of the item, a depth of the item, orientation information for the item, and/or a merchandise style for the item. The item data written to the .psa file may include information extracted from the library of item data and/or one or more template planograms discussed above, and may include more item data that was not received from mobile communication device 8000 at 5005.

For example, as shown in FIG. 1, item 110 has a height 110h and a width 110w. Item 110 may also have a depth 110d (not shown), which may be used along with a fixture depth to determine a number of units of item 110 that can be located on shelf 21 of fixture segment 20. This quantity information may be useful for inventory or other supply chain management functions.

As discussed above, orientation information for an item may specify how units of the item are to be oriented on a fixture. For example, orientation information for a rectangular item may specify whether the item is to be placed on a shelf with its longer dimension oriented horizontally or vertically.

As discussed above, a merchandise style for an item may specify, for example, the manner in which units of the item are grouped on a fixture.

At 5020, the .psa file is populated with segment data regarding the one or more display segments to be depicted in the planogram. Segment data includes, for example, a number of display segments to be represented in the planogram, a total width of a given display segment, a name for the given display segment, and/or other data regarding the given display segment.

At 5025, a vertical location is determined for a fixture on which a first row of items is located, which may be a height of a shelf on which units of the items are displayed, and the .psa file is populated with data corresponding to this row/shelf location. Preferably, the method 5000 proceeds by initially writing fixture location data for the lowest shelf or row of a display segment (which may be a default value for the lowest fixture), and proceeding to write fixture location data for the second lowest shelf, and so on. While the examples discussed herein follow this ‘bottom-up’ approach, it will be appreciated that a lop-down′ approach may also be possible.

At 5030, the .psa file is populated with fixture data for the fixture for which a vertical location was determined at 5025. Fixture information includes a height, width, and depth for a fixture, along with location information for the fixture. Fixture location information may be expressed in X, Y and Z coordinates as the distance from the back-bottom-left corner of the display segment (or planogram) in the right-left, up-down, and forward-back directions respectively.

A name for the fixture may also be included. The name for a fixture may be based on the segment and/or relative location of the fixture. For example, the name for a shelf may be “SHELF-<segment number>-<shelf number>” (e.g. for FIG. 1, the name for shelf 22 may be “SHELF-1-2”, and shelf 25 may be named “SHELF-1-5”.

Fixture information may also include settings for one or more fixture (shelf) attributes. For example, a fixture setting (e.g. a “can combine” setting) may indicate whether or not fixtures (e.g. shelves) in adjacent display segments (such as 20 and 20b, or 20b and 20c in FIG. 2) that are vertically aligned (i.e. fixtures in adjacent display segments with the same Y coordinates, or with the same Y and Z coordinates) are permitted to act as contiguous fixtures (e.g. shelves).

As discussed further below, the recorded position data received at 5005 for one or more display segments may not contain any item position data (e.g. for a ‘jump shelf’ planogram). In some embodiments, where the recorded position data contains an ‘empty segment’ (i.e. a display segment with no item position data), the fixture data for the preceding display segment (including the height, width, and/or depth of the fixtures, and/or height and depth location information for the fixtures (e.g. a shelf profile)) may be copied and used for the fixtures in the ‘empty’ display segment. Also, a fixture (shelf) attribute for the fixtures in the ‘empty’ segment and the preceding segment may be provided to indicate that vertically aligned fixtures may act as contiguous fixtures. For example, the .psa data file may indicate that a “can combine” property is to be assigned to the fixtures in the ‘empty’ display segment and the fixtures in the preceding segment.

At 5035, a maxitem_height counter is set (or reset) to 0. The purpose for this counter will be discussed further below.

At 5040, the .psa file is populated with position data for a first of one or more items located on the fixture (e.g. shelf) for which data was populated at 5030. The position data for each item is based on the recorded position data that was received at 5005, and may also be based on the location information for the fixture determined at 5025 and written at 5030. The position data may include a number of facings for each item on the fixture. For example, looking at row 11 of FIG. 1 as an example, position data for item 110 may comprise location coordinates (0/21h/0). Position data for each item may also include orientation information and/or merchandise style information.

Preferably, position data for the one or more items located on the fixture is written to the .psa file in the order in which the items were encountered on the fixture (i.e. in the order the location data for the item was recorded. That is, the position data for the one or more items is recorded in the .psa file in the same sequence in which the one or more items are located on the fixture. For example, looking at FIG. 1 as an example, position data for the items in row 11 are preferably recorded in the .psa file in the order 110, 112, 114, 116, 118.

Alternatively, position data written to the .psa file for the one or more items may include a horizontal coordinate component, which may be based on, for example, a width and/or number of facings of the preceding items. For example, looking again at FIG. 1, position data for the item 112 may be based on the width 110w of item 110 (e.g. (110w/21h/0)).

In some embodiments, position data for each item may comprise an index pointer to the item data written to the .psa file in 5015, along with a number of facings of the item. For example, position data for item 110 may be provided in the form (110, 1) indicating 1 facing for item 110.

At 5045, an item height (which may be referred to as a merchandise height), is determined for the item for which position data was written in 5040. When determining an item height for an item, one or more of the item height, item width, and item depth may be extracted from data provided in a library of item data and/or one or more template planograms. Also, one or more of the orientation information, merchandise style, and a default ‘units high’ value for an item may be extracted from data provided in a template planogram. For example, in FIG. 1, the item height for item 210 is 2×210h, as two units 210a, 210b of item 210 are stacked for each facing of item 210.

An item height for each item is determined at 5045 so that a maximum item height for a row of items on a fixture may be determined. The maximum item height is based on the item that has the greatest overall vertical dimension, which may include more than one unit for a given item. The overall vertical dimension for an item may be determined based on one or more of the item dimensions (i.e. height, width, and/or depth) and based on one or more of an item orientation, item merchandise style, and/or item stacking indicator. For example, if item data for an item indicates a unit of that item has a height of 30 cm, a width of 20 cm, and a depth of 10 cm, and the merchandise style for that item is ‘front’ or ‘side’, the overall vertical dimension may be 30 cm. However, if the same item has a ‘top’ merchandise style, the overall vertical dimension may be 10 cm. Further, if the same item has a “top” merchandise style and a “units high” value of 5, the overall vertical dimension may be 5×10=50 cm.

For example, in FIG. 1, none of items 110-118 in row 11 are stacked, so the maximum height 11hₘₐₓ for items on fixture 21 will be equal to the height of the tallest item. In row 13, where two stacked units are provided for each facing of items 310, 312, and 314, but only one unit of item 316 is provided per facing, the maximum height 13hₘₐₓ for items on shelf 23 will be equal to the largest of [(2×310h), (2×312h), (2×314h), (316h)].

At 5050, the item height for the item for which position data was written in 5040 is compared with the max_item_height counter. If the determined item height is greater than the current value of max_item_height, the max_item_height counter is updated to reflect this item height at 5055, and then method 5000 proceeds to 5060. If the determined item height is less than the current value of max_item_height, the method 5000 proceeds to 5060 without updating the max_item_height counter.

At 5060, if the received position data indicates that there are more items located on the current fixture, the method 5000 returns to 5040, and position data for the next item on the fixture is written to the .psa file. Otherwise, the method proceeds to 5065.

At 5065, if the received position data indicates that there are more fixtures (e.g. shelves) in the current display segment, the method returns to 5025, and a vertical location is determined for the next fixture. When determining a vertical location for the next fixture, the location may be based on the vertical location of the previous fixture, and the maximum item height for the items supported on the previous fixture. For example, looking at FIG. 1, if the height 21h of fixture (shelf) 21 supporting the first row of items 11 was 30 cm, and the maximum item height 11hₘₐₓ for the items in row 11 was 46 cm, the height 22h of fixture (shelf) 22 should be at least 76 cm.

The vertical location for a subsequent fixture may also be based on a fixture (e.g. shelf) thickness, as shelves typically have a vertical thickness to allow for sufficient structural rigidity for supporting items, and/or to provide a location for signage associated with the items, such as pricing, promotional, and/or other information. As shown in FIG. 1, for example, fixture (shelf) 21 may have a thickness 21t, and fixture 22 may have a thickness 22t.

In some embodiments, the vertical location for a subsequent fixture may also be based on a predetermined “finger space amount” 11f, to reflect a gap that should be present between the tops of items in a row of items and the underside of a fixture (e.g. shelf) above them, to facilitate the placement (and removal) of items by a stock-person (or consumer). Such a “finger space amount” may be, for example, between 2 and 7 cm, or between 4 and 6 cm. Accordingly, in the example noted above, where the height 22h of shelf 22 should be at least 76 cm based on the on the vertical location of the previous fixture (i.e. 21h), and the maximum item height for the previous row of items (i.e. 11hₘₐₓ), if a 3 cm finger space amount 11f is used, the height 22h may be determined as 76+3=79 cm.

Alternatively, or additionally, the vertical location for a subsequent fixture may also be based on fixture (e.g. shelf) spacing data for the current display segment, as a given display segment may only allow fixtures (e.g. shelves) to be installed at certain predetermined intervals. For example, display segment 20 may have a support frame with a plurality of holes, notches, or slots vertically spaced at 2.5 cm intervals, and individual shelves may be mounted using one or more of the plurality of holes, notches, or slots. Accordingly, returning to the previous example, if the height 22h of shelf 22 should be at least 76 cm based on the on the vertical location 21h of the previous fixture, the maximum item height 11hₘₐₓ for the previous row of items, and the shelves are provided at 2.5 cm intervals, the height 22h may be determined by rounding up to the nearest possible shelf height, e.g. (roundup (76/2.5))*2.5=31*2.5=77.5 cm.

In some embodiments, the vertical location for a subsequent fixture may be based on the vertical location of the previous fixture, the maximum item height for the previous row of items, a finger space amount, and on shelf spacing data for the current display segment type. Returning once again to the example noted above, if the height 22h of shelf 22 should be at least 76 cm based on the on the vertical location of the previous fixture and the maximum item height for the previous row of items, if a 3 cm finger space amount 11f is used and the shelves are provided a 2.5 cm intervals, the height 22h may be determined by rounding up to the finger-space-adjusted-height to the nearest possible shelf height, e.g. round up ((76+3)/2.5)*2.5=32*2.5=80 cm.

If at 5065 the received position data does not indicate that there are more fixtures in the current display segment, the method 5000 proceeds to 5070, where it is determined whether or not there is position data for more display segments. If so, the method returns to 5020, and if not the method proceeds to 5075, where the .psa file is closed.

Optionally, at 5080, the completed .psa file is transmitted by the remote computing device 7000. Transmitting the .psa file may include one or more of: saving the completed file to a database accessible to the remote computing device 7000, copying the completed file to a remote data base via a File Transfer Protocol (FTP) service, and sending a copy of the completed file to one or more email addresses.

While in the above examples the position data was written to the .psa file in a left-to-right order, it will be appreciated that the position data may alternatively be written in a right-to-left order. For example, position data for first row 11 as shown in FIG. 1 may comprise an indication that item 118 is in the right-most position of row 11, that item 116 is adjacent to item 118, and so on for items 114, 112, and 110. Similarly, while in the above examples the position data was written to the .psa file in a bottom-to-top order, it will be appreciated that the position data may alternatively be written in top-to-bottom order.

It will also be appreciated that the maximum item height for a row of items may be determined without the use of a max_item_height counter. For example, once position data for a row of items has been written to the .psa file, the item height data may be retrospectively calculated in order to determine the maximum item height for a row.

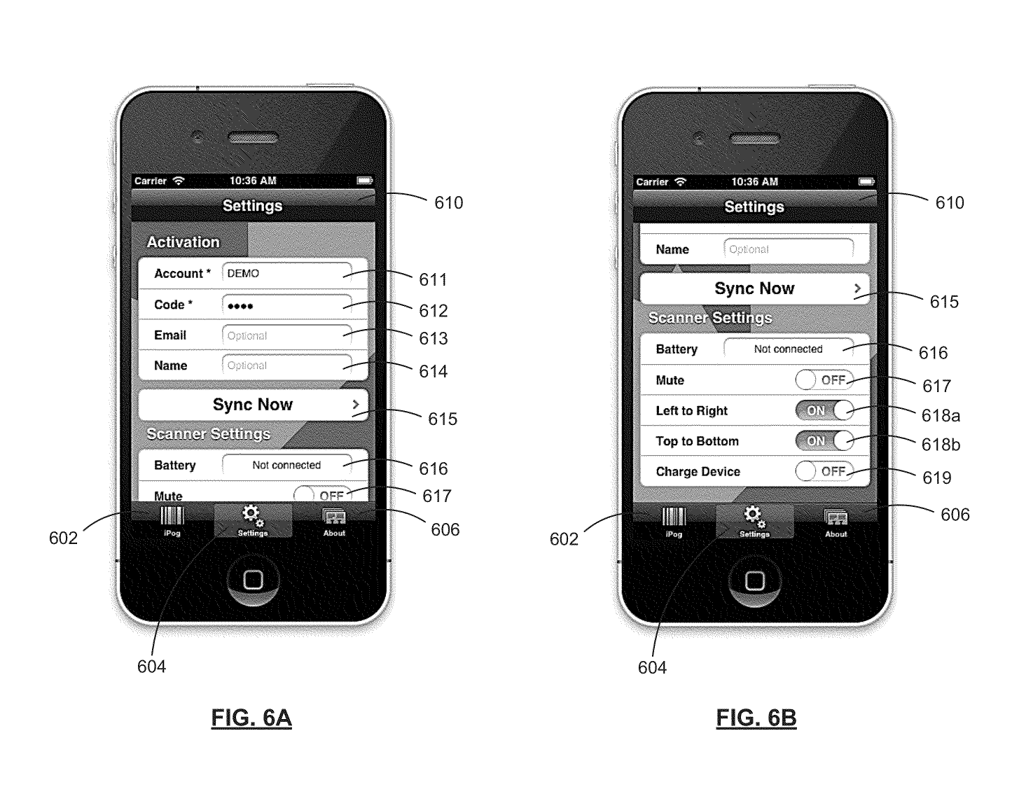

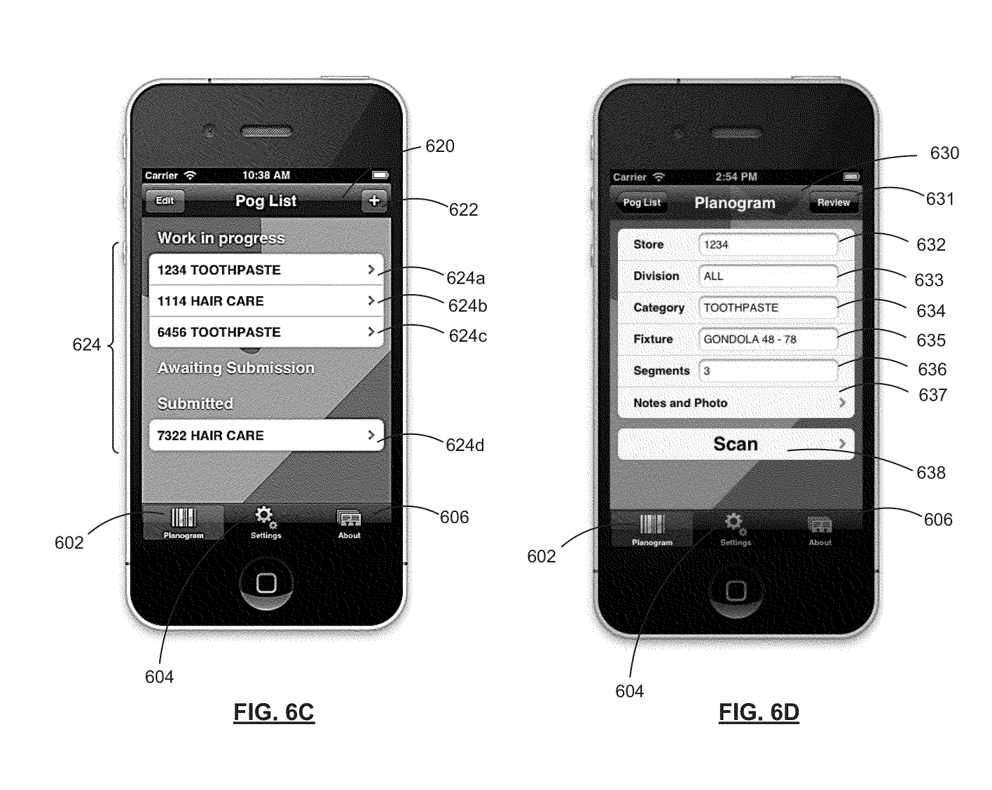

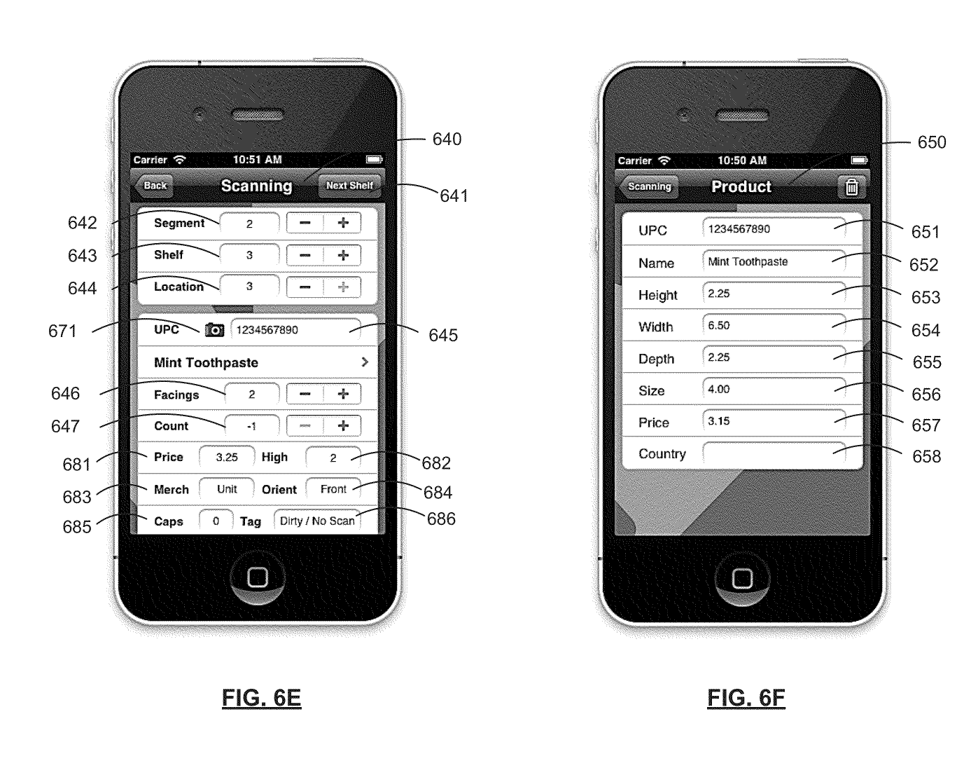

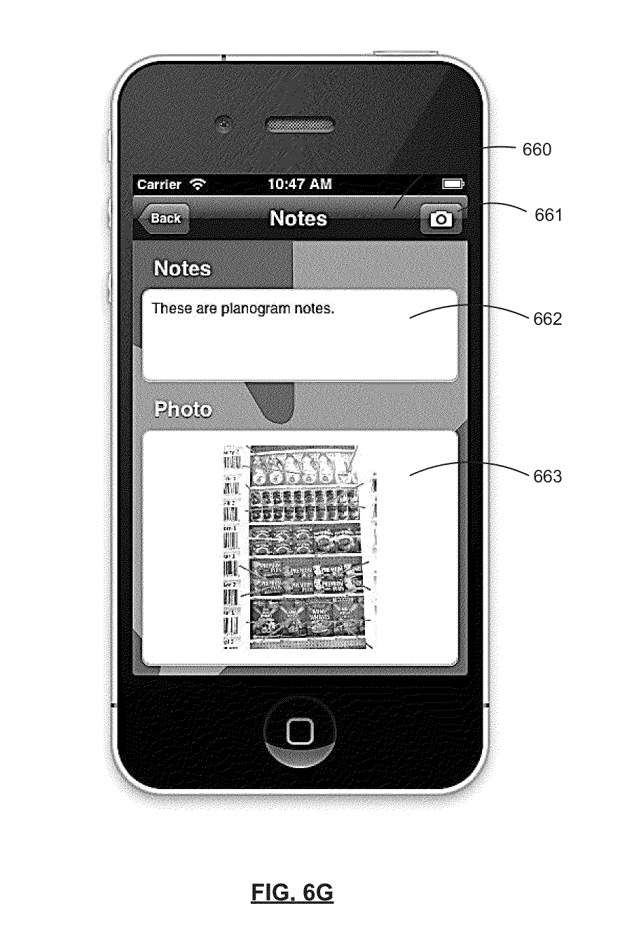

Reference is next made to FIGS. 6a-g, illustrating examples of a user interface that may be displayed by an example embodiment of a mobile communication device 8000 during execution of all or part of method 4000. In this example, mobile communication device 8000 is a smart phone but in other embodiments other mobile devices that can provide similar functionality may be used.

FIGS. 6a and 6b illustrate an example settings window 610 displayed by mobile communication device 8000, which may be accessed, for example, by selecting settings icon 604 located at the bottom of the user interface.

Settings window 610 includes an account entry field 611, a password entry field 612, and an e-mail address field 613. A user name field 614 may also be provided, to provide an indication of a user who recorded data using mobile communication device 8000, which may be useful is more than one user has access to the account entered in field 611.

Sync icon 615 allows a user to indicate that item data, fixture data, and/or template planogram data should be synchronized (e.g. downloaded or updated) from remote computing device 7000 to mobile communication device 8000, as discussed above.

Settings window 610 can also provide settings related to an associated scanner (e.g. a barcode scanner or a camera), such as battery settings 616, and a mute toggle 617 for selectively suppressing an audible output of the scanner. Settings related to the operation of the scanner such as, but not limited to toggles 618a-b and 619 for example, may be provided. Toggle 618a is used to indicate whether position data for one or more items on a fixture will be entered in a left-to-right, or right-to-left order, as discussed above. Toggle 618b is used to indicate whether position data for one or more fixtures will be entered in a bottom-to-top, or top-to-bottom order, as discussed above. Where the power source of a scanner associated with mobile communication device 8000 can be used to charge a power source of mobile communication device 8000, toggle 619 may be used to select whether mobile communication device 8000 draws power from the scanner's power source.

FIG. 6c illustrates an example position data file window 620 (which may be referred to as a scan list, or Pog list) displayed by mobile communication device 8000, which may be accessed, for example, by selecting an icon 602 located at the bottom of the user interface.

Position data file window 620 includes a new file icon 622 for initiating the creation of a new position data file from which a planogram is to be generated, and also provides a list 624 of previously created position data files 624a-d. As shown, position data files that have been previously submitted to remote computing device 7000 (e.g. data files 624a-c) may be demarcated from position data files that have not yet been submitted to remote computing device 7000 (e.g. data files 624d).

In some embodiments, once a position data file has been created or opened from position data file window 620, a planogram information window 630 (an example of which is illustrated in FIG. 6d) may be displayed.

Planogram information window 630 can allow a user to enter or modify data related to the planogram to be generated from the recorded position data. Planogram information window 630 includes a store identifier entry field 632, a division selection menu 633, a category selection menu 634, a fixture selection menu 635, and a segment number entry field 636.

As discussed above, one or more of division selection menu 633, category selection menu 634, and fixture selection menu 635 may be presented as drop-down lists populated with data received at mobile communication device 8000 at step 4005 of method 4000.

Planogram information window 630 may also include a link 659 to a notes window, such as notes window 660 shown in FIG. 6g. Notes window 660 includes a camera icon 661, for accessing a camera associated with mobile communication device 8000 to capture one or more images related to the display segment for which position data is being recorded. These photos may be shown in field 663. Also, text notes may be entered in field 662.

Returning to FIG. 6d, once data related to the planogram has been entered or modified, scan icon 638 may be selected to proceed to scanning window 640, an example of which is illustrated in FIG. 6e.

Scanning window 640 includes: segment location field 642, which indicates the current display segment for which position data is being recorded; shelf location field 643, which indicates the fixture/shelf for which position data is being recorded; and location field 644, which indicates the number (i.e. quantity) of units of the item that are present on the current fixture. Entering an item identifier in field 645 (e.g. using a barcode scanner or camera associated with mobile communication device 8000, or via a user interface) automatically sets the value in location field 644 to 1. If no item identifier is present in field 645 (e.g. after selecting “next shelf” icon 641 but before entering an item identifier in field 645), location field 641 may default to 0.

Scanning window 640 also includes item identifier field 645, where an item identifier, such as a UPC code, is recorded. As discussed above, data for identifier field 645 may be captured using a scanner associated with mobile communication device 8000 (e.g. by actuating a scan button on the scanner), captured using a camera of mobile communication device 8000 (e.g. using button 671) or it may be manually entered by a user.

Scanning window 640 also includes facing data field 646, where a number of facings of that item present on the fixture shelf can be recorded. As discussed above, data for facing data field 646 may be incremented by sequentially scanning multiple instances of an item identifier using a scanner associated with mobile communication device 8000, or the number of facings for an item may be manually entered and/or adjusted by a user, e.g. by tapping the +/− buttons and/or using a number pad.

Scanning window 640 also includes count field 647, where a quantity of units of the item present on the fixture shelf can be recorded. As discussed above, data for count field 647 may be manually entered by a user. A default value of −1 may be used to indicate that the count was not reviewed by the user. An entry of zero may indicate that the product was not found (e.g. where the user scanned a shelf tag). A count greater than zero may indicate that a physical count was completed.

Scanning window 640 also includes item name field 648, where a name for the item whose item identifier is shown in identifier field 645. If no name is found in the item data stored on mobile communication device 8000 for an entered item identifier, a default name (e.g. “unknown”) may be displayed. Entry of an unrecognized item identifier, and/or selecting name field 648 may cause item window 650 to be displayed, as will be discussed further below.

Scanning window 640 also includes: item price field 681, in which a user can record or adjust a price displayed or otherwise associated with the item identified in field 645; item ‘units high’ field 682, in which a user can record or adjust a number of units in a stack of the item identified in field 645; item merchandise style field 683, in which a user can record or adjust merchandise style information (as discussed above) for the item identified in field 645; item orientation field 684, in which a user can record or adjust orientation information (as discussed above) for the item identified in field 645; item top caps field 685, in which a user can record or adjust a number of units of the item identified in field 645 that are stacked differently than the primary orientation (see e.g. units 116a and 116b of item 116 in FIG. 1); and item tag field 686, in which a user can record or adjust any observed shelf tag issues (e.g. note that a shelf tag was missing, handwritten, dirty, unable to be scanned).

If an unknown item identifier is entered in item identifier field 645, such as an item identifier that is not included in the item data and/or template planogram data that was synchronized to mobile computing device 8000, as discussed above, an item window 650 (see FIG. 6f) may be displayed.

FIG. 6f illustrates an item window 650 that includes: item identifier field 651, in which an item identifier, such as a UPC code, is recorded; item name field 652, in which an item name can be recorded; and item height, width, and depth fields 653, 654, and 655, respectively, in which item dimensions can be recorded; item size field 656, in which an item size (e.g. volume or mass) can be recorded; item price field 657, in which an item price can be recorded; and item country field 658, in which a shelf-identified country of origin (which may be useful for certain beverages and/or “fresh” items (e.g. produce, dairy, or meat).

It should be noted that there may be other embodiments of the user interface of FIGS. 6a-g in which the position of the various entry fields are changed or there may be more or fewer entry fields that may be used.

In some embodiments, the systems and methods described herein may facilitate the generation of planograms that include jump shelves. The term “jump shelves” may be used to describe a planogram that has different fixture (e.g. shelf) profiles within the same planogram, for example where the shelves of two or more adjacent display segments are vertically aligned, and the shelves of one or more other adjacent display segment ‘jump’ slightly from the shelves of the aligned display segments. It will be appreciated that the term jump shelf is not restricted to planograms where the last (e.g. end) segment is different from the remainder of the planogram. For example, it is possible to have fixture (shelf) counts of 5/5/6/5/4/6 or 5/5/5/6/6/5, for example, for six adjacent display segments.

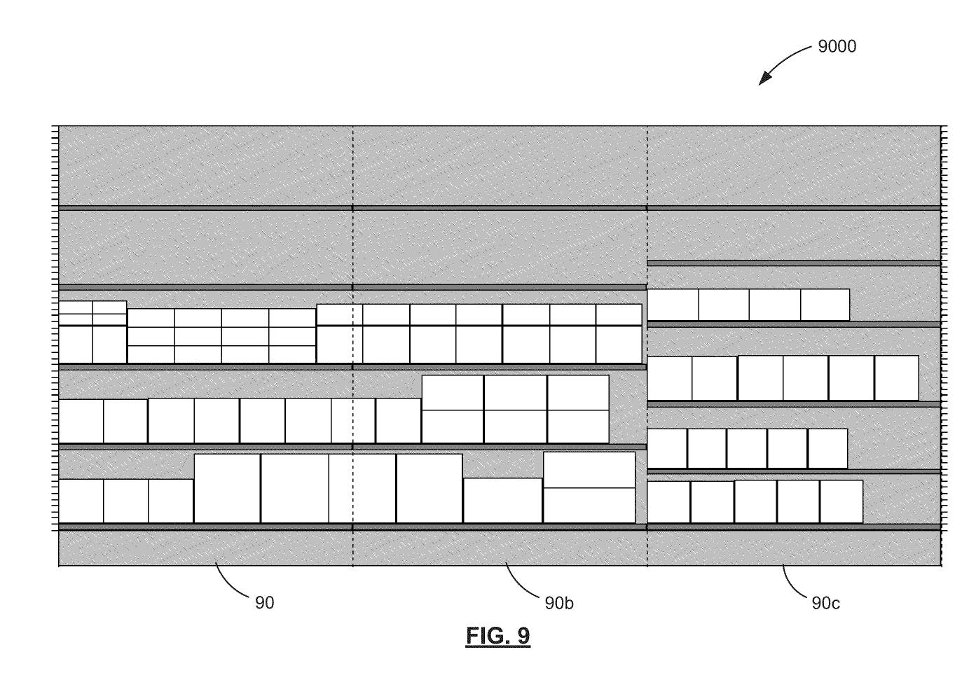

An example of a planogram with a jump shelf is shown in FIG. 9. Example planogram 9000 includes display segments 90, 90b, and 90c. Display segments 90, 90b, and 90c can be separately shelved segments of a discrete physical shelving unit, or adjacently arranged (but physically separate) shelving units. As can be seen in the example of FIG. 9, display segments 90 and 90b each have 5 fixtures (shelves), and the fixtures for display segments 90 and 90b are vertically aligned with each other. Display segment 90c has 6 fixtures (shelves), and while the base (lowest) shelf is aligned with the base shelves of display segments 90 and 90b, and while the top (highest) shelf is aligned with the top shelves of display segments 90 and 90b, the remaining shelves for display segment 90c are not vertically aligned with the shelves for display segments 90 and 90b (e.g. planogram 9000 may be referred to as having fixture (shelf) counts of 5/5/6).

In some embodiments, a data file for a planogram with jump shelves may be generated by treating display segments with common shelving as a single display segment when recording position data using mobile communication device 8000. For example, a user may create a new position data file and indicate that there are three display segments for which position data is to be recorded. However, when recording position data, a user may start by recording position data for the one or more items along the base shelf of display segment 90, and then continue recording position data for one or more items along the base shelf of display segment 90b without incrementing the fixture or segment indicators. After recording position data for the items on the base shelves for display segments 90 and 90b, the user may provide a ‘next shelf/fixture’ indication, and then record position data for the items along the second lowest shelf of display segments 90 and 90b. Put another way, the user may record position data as if the first two display segments 90 and 90b were a single display segment,

After position data has been recorded for the items on display segments 90 and 90b, a user may provide a “next segment” indication twice, or otherwise indicate that they are now recording position information for items located on the third display segment, and proceed to record position data for display segment 90c, starting along the base shelf of display segment 90c. Note that position data for items located on the second of the three display segments (i.e. display segment 90b) was recoded as if the items were located on the fixtures of the first display segment 90, and that no position data was recorded as being associated with the second display segment 90b.

When the recorded position data for this ‘jump shelf’ planogram is written to a planogram data file by remote computing device 7000, as noted above an indication may be provided in the .psa file (e.g. at 5030) that items are allowed to ‘overflow’ (e.g. overrun) the fixtures for the first and second display segments (i.e. 90 and 90b), but not the fixtures in the third display segment 90c. For example, data may be written to the .psa file to indicate that the fixtures for display segments 90 and 90b are assigned a “can combine” property, and that the fixtures for display segment 90c, including fixtures that are vertically aligned with fixtures in display segment 90b (e.g. the base shelf and the top shelf), are not assigned the “can combine” property. Accordingly, when the position data file is accessed, while the items located on both segments 90 and 90b will be associated with the fixtures (shelves) of segment 90 only (and the shelves of segment 90b will actually be empty), the items for segment 90 will be permitted to ‘overflow’ into the (empty) shelves of segment 90b, but not into the shelves of segment 90c, and therefore will be located in the correct location.

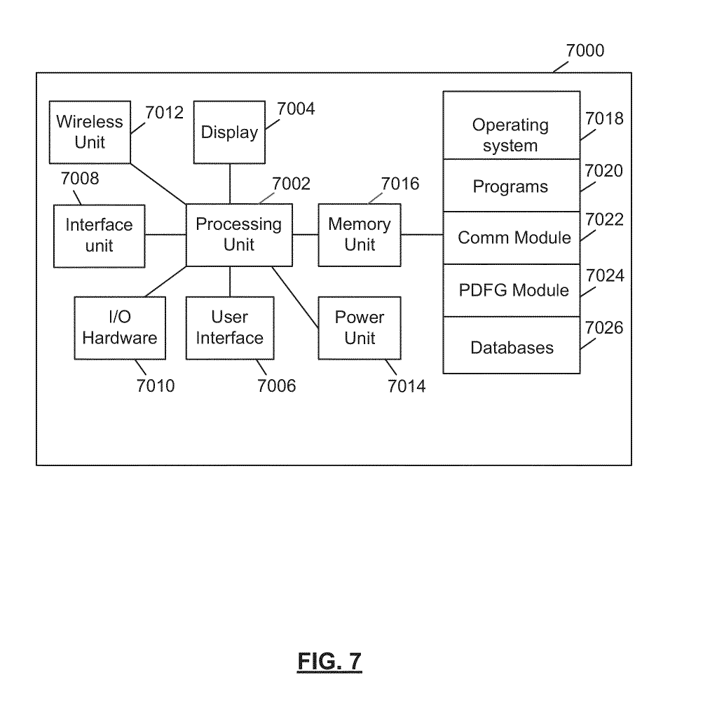

Reference is next made to FIG. 7 illustrating a block diagram of a remote computing device 7000 in accordance with an example embodiment. Remote computing device 7000 is provided as an example and there can be other embodiments of computing device 7000 with different components or a different configuration of the components described herein. Remote computing device 7000 further includes several power supplies (not all shown) connected to various components of computing device 7000 as is commonly known to those skilled in the art.

Remote computing device 7000 comprises processing unit 7002, display 7004, user interface 7006, interface unit 7008, Input/Output (I/O) hardware 7010, wireless unit 7012, power unit 7014 and memory unit 7016. Memory unit 7016 comprises software code for implementing operating system 7018, various programs 7020, communications module 7022, planogram data file generation module 7024, and one or more databases 7026. Many components of computing device 7000 can be implemented using a desktop computer, a server or any other suitable device.

Processing unit 7002 controls the operation of remote computing device 7000. Processing unit 7002 can be any suitable processor, controller or digital signal processor that can provide sufficient processing power processor depending on the configuration, purposes and requirements of remote computing device 7000 as is known by those skilled in the art. For example, processing unit 7002 may be a high performance general processor. In alternative embodiments, processing unit 7002 can include more than one processor with each processor being configured to perform different dedicated tasks. In alternative embodiments, it may be possible to use specialized hardware to provide some of the functions provided by processing unit 7002.

Display 7004 can be any suitable display that provides visual information depending on the configuration of remote computing device 7000. For instance, display 7004 can be a cathode ray tube, a flat-screen monitor, an LCD display and the like if computing device 7000 is a desktop computer or a server computer.

User interface 7006 can include at least one of a mouse, a keyboard, a touch screen, a thumbwheel, a track-pad, a track-ball, a card-reader, voice recognition software and the like again depending on the particular implementation of remote computing device 7000. In some cases, some of these components can be integrated with one another.

Interface unit 7008 can be any interface that allows remote computing device 7000 to communicate with other devices or computers. In some cases, interface unit 7008 can include at least one of a serial port, a parallel port or a USB port that provides USB connectivity. Interface unit 7008 can also include at least one of an Internet, Local Area Network (LAN), Ethernet, Firewire, modem or digital subscriber line connection. Various combinations of these elements can be incorporated within interface unit 7008.

I/O hardware 7010 is optional and can include, but is not limited to, at least one of a microphone, a speaker and a printer, for example.

Wireless unit 7012 is optional and can be a radio that communicates utilizing CDMA, GSM, GPRS or Bluetooth protocol according to standards such as IEEE 802.11a, 802.11b, 802.11g, or 802.11n. Wireless unit 7012 can be used by the remote computing device 7000 to wirelessly communicate with other devices or computers.

Power unit 7014 can be any suitable power source that provides power to remote computing device 7000 such as a power adaptor or a rechargeable battery pack depending on the implementation of remote computing device 7000 as is known by those skilled in the art.

Memory unit 7016 can include RAM, ROM, one or more hard drives, one or more flash drives or some other suitable data storage elements such as disk drives, etc. Memory unit 7016 is used to store operating system 7018 and programs 7020 as is commonly known by those skilled in the art. For instance, operating system 7018 provides various basic operational processes for remote computing device 7000. Programs 7020 include various user programs so that a user can interact with remote computing device 7000 to perform various functions such as, but not limited to, viewing and manipulating data as well as sending messages as the case may be.

Memory unit 7016 may also accept data from one of the input devices, communications module 7022, and planogram data file generation module 7024. Memory unit 7016 uses the received data to define and store, for example, the library of item data, library of fixture data, and the template planogram discussed above.

Communications module 7022 interacts with database 7026 and interface unit 7008 in order to transfer data to, and receive data from, mobile communication device 8000.

Planogram data file generation module 7024 interacts with database 7026 and interface unit 7008 in order receive recorded position data from mobile communication device 8000, and to generate a planogram data file as discussed above with respect to methods described according to the teachings herein an example of which is shown in FIG. 5, for example

It should be noted that in alternative embodiments, modules 7022 and 7024 may be combined or may be separated into further modules. Furthermore, modules 7022 and 7024 are typically implemented using software, but there may be embodiments in which they may be implemented using application specific circuitry or some other suitable technique.

Databases 7026 can be used to store data for remote computing device 7000 such as system settings, parameter values and account information for users of system 3000. Databases 7026 can also store other information required for the operation of programs 7020 or operating system 7018 such as dynamically linked libraries and the like.

Remote computing device 7000 comprises at least one interface that processing unit 7002 communicates with in order to receive or send information. This interface can be user interface 7006, interface unit 7008 or wireless unit 7012. For instance, information for generating a planogram data file may be inputted by someone through user interface 7006 or it can be received through interface unit 7008 from another computing device. Processing unit 7002 can communicate with either one of these interfaces as well as display 7004 or I/O hardware 7010 in order to output information related to generating a planogram data file, for example. In addition, users of remote computing device 7000 can use interface unit 7008 to communicate information across a network connection to a remote system for planogram storage and/or further analysis. This communication can also include, but is not limited to, email communication, for example.

The user can also use remote computing device 7000 to input information that is needed for system parameters that are needed for proper operation of system 3000 such as various parameter values and other system operating parameters as is known by those skilled in the art. Data that is obtained from mobile communication device 8000 as well as parameters used for operation of system 3000, may be stored in memory unit 7016. The stored data may include one or more planograms as well as other data in accordance with the teachings herein.

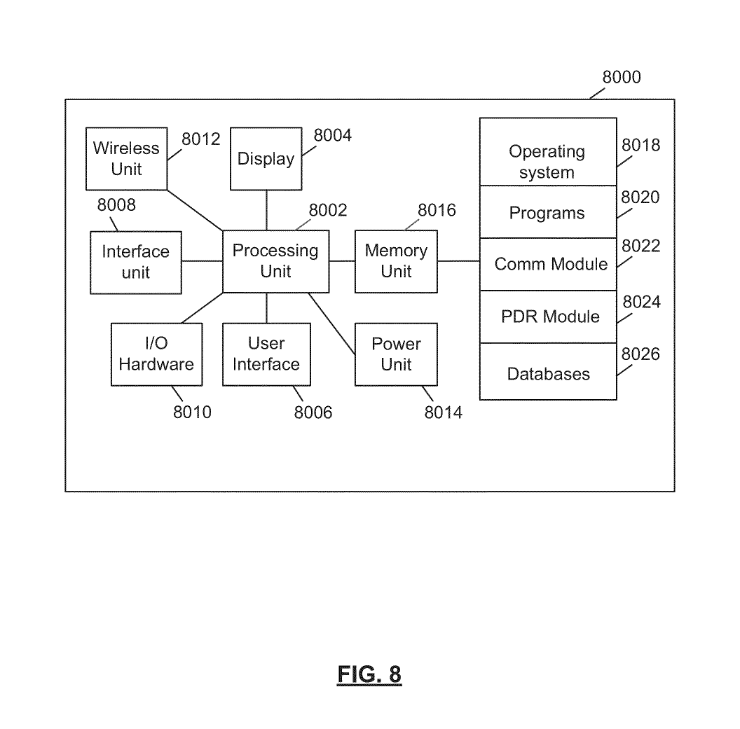

Reference is next made to FIG. 8 illustrating a block diagram of mobile communication device 8000 in accordance with an example embodiment. Mobile communication device 8000 is provided as an example and there can be other embodiments of mobile communication device 8000 with different components or a different configuration of the components described herein.

Mobile communication device 8000 comprises processing unit 8002, display 8004, user interface 8006, interface unit 8008, Input/Output (I/O) hardware 8010, wireless unit 8012, power unit 8014 and memory unit 8016. Memory unit 8016 comprises software code for implementing operating system 8018, various programs 8020, communications module 8022, position data recording module 8024, and one or more databases 8026. Many components of mobile communication device 8000 can be implemented using a mobile phone, a laptop computer, a tablet, and the like including other suitable mobile devices. In some embodiments, mobile communication device 8000 can be a smart phone that is coupled with an appropriate scanner as described in more detail below.

Processing unit 8002 controls the operation of the mobile communication device 8000. Processing unit 8002 can be any suitable processor, controller or digital signal processor that can provide sufficient processing power processor depending on the configuration, purposes and requirements of mobile communication device 8000 as is known by those skilled in the art. For example, processing unit 8002 may be a high performance general processor. In alternative embodiments, processing unit 8002 can include more than one processor with each processor being configured to perform different dedicated tasks. In alternative embodiments, specialized hardware may be used to provide some of the functionality provided by processing unit 8002.

Display 8004 can be any suitable display that provides visual information depending on the configuration of mobile communication device 8000. For instance, display 8004 can be a display suitable for a laptop, tablet or handheld device such as an LCD-based display and the like.

User interface 8006 can include at least one of a keyboard, a touch screen, a thumbwheel, a track-pad, a track-ball, a card-reader, voice recognition software and the like again depending on the particular implementation of mobile communication device 8000. In some cases, some of these components can be integrated with one another.

Interface unit 8008 can be any interface that allows the mobile communication device 8000 to communicate with other devices or computers. In some cases, the interface unit 8008 can include at least one of a serial port, a parallel port or a USB port that provides USB connectivity. Interface unit 8008 can also include at least one of an Internet, Local Area Network (LAN), Ethernet, Firewire, modem or digital subscriber line connection. Various combinations of these elements can be incorporated within interface unit 8008.

I/O hardware 8010 generally includes a camera, a barcode scanner (which may be a peripheral barcode scanner such as a LineaPro scanner as available from Infinite Peripherals of Arlington Heights, Ill. (see http://ipcprint.com), a Captuvo SL22 series scanner sled as available from Honeywell Scanning & Mobility of Blackwood, N.J. (see http://www.honeywellaidc.com), or any other suitable scanner or scanning sled or a combination of at least two of the following: a camera, a scanner and a scanner sled . . . I/O hardware 8010 may optionally also include at least one of a microphone, a speaker and a printer, for example.

Wireless unit 8012 is optional and can be a radio that communicates utilizing CDMA, GSM, GPRS or Bluetooth protocol according to standards such as IEEE 802.11a, 802.11b, 802.11g, or 802.11n. Wireless unit 8012 can be used by mobile communication device 8000 to wirelessly communicate with other devices or computers.

Power unit 8014 can be any suitable power source that provides power to mobile communication device 8000 such as a power adaptor or a rechargeable battery pack depending on the implementation of mobile communication device 8000 as is known by those skilled in the art.

Memory unit 8016 can include RAM, ROM, one or more hard drives, one or more flash drives or some other suitable data storage elements such as disk drives, etc. Memory unit 8016 is used to store an operating system 8018 and programs 8020 as is commonly known by those skilled in the art. For instance, operating system 8018 provides various basic operational processes for mobile communication device 8000. Programs 8020 include various user programs so that a user can interact with the mobile communication device 8000 to perform various functions such as, but not limited to, viewing and manipulating data as well as sending messages as the case may be.

Memory unit 8016 may also accept data from one of the input devices, communications module 8022, and position data recording module 8024. Memory unit 8016 uses the received data to define and store, for example, at least a subset of a library of item data and/or at least a subset of a library of fixture data, and recorded position data for one or more items, as discussed above with respect to methods described according to the teachings herein an example of which is shown in FIG. 4, for example.

Communications module 8022 interacts with database 8026 and interface unit 8008 in order to transfer data to, and receive data from, remote communication device 7000.

Position data recording module 8024 interacts with database 8026 and interface unit 8008 in order to record position data received via a scanner provided as part of I/O hardware 8010 and/or user interface 8006, as discussed above with respect to methods described according to the teachings herein an example of which is shown in FIG. 4, for example.

It should be noted that in alternative embodiments, modules 8022 and 8024 may be combined or may be separated into further modules. Furthermore, modules 8022 and 8024 are typically implemented using software, but there may be embodiments in which they may be implemented using application specific circuitry or some other suitable techniques.

Databases 8026 can be used to store data mobile communication device 8000 such as system settings, parameter values and account information for users of system 3000. Databases 8026 can also store other information required for the operation of programs 8020 or operating system 8018 such as dynamically linked libraries and the like.

Mobile communication device 8000 comprises at least one interface that processing unit 8002 communicates with in order to receive or send information. This interface can be user interface 8006, interface unit 8008 or wireless unit 8012. For instance, position data for one or more items may be inputted by someone through user interface 8006 or using a scanner provided as part of I/O hardware 8010. Processing unit 8002 can communicate with either one of these interfaces as well as display 8004 or I/O hardware 8010 in order to output recorded position data, for example. In addition, users of mobile communication device 8000 can use interface unit 8008 to communicate information across a network connection to a remote system for generating a planogram data file. This communication can also include, but is not limited to, email communication, for example.

The user can also use mobile communication device 8000 to input information that is needed for system parameters that are needed for proper operation of system 3000 such as various parameter values and other system operating parameters as is known by those skilled in the art. Data that is obtained from mobile communication device 8000 as well as parameters used for operation of system 3000, may be stored in memory unit 8016. The stored data may include one or more position data files, planograms, as well as other data in accordance with the teachings herein.

Various embodiments of systems, devices and methods that can be used to generate a planogram data file have been described herein by way of example only. Various modifications and variations may be made to these example embodiments without departing from the spirit and scope of the embodiments, which is limited only by the appended claims which should be given the broadest interpretation consistent with the description as a whole.

We claim:

1. A method for generating a planogram data file, the method comprising:
receiving, at a remote computing device, first recorded position data for one or more first items located on a first fixture of a display segment, and second recorded position data for one or more second items located on a second fixture of the display segment;
generating, using the remote computing device, a planogram data file, by:
writing first item data for the one or more first items and second item data for the one or more second items to the planogram data file;
writing fixture location data for the first fixture to the planogram data file;
writing, based on the first recorded position data, first position data for the one or more first items to the planogram data file;
determining, based on the first item data, a first maximum item height for the one or more first items;
writing, based on the first maximum item height, fixture location data for the second fixture to the planogram data file; and
writing, based on the second recorded position data, second position data for the one or more second items to the planogram data file.

2. The method of claim 1, wherein the first recorded position data and the second recorded position data is received from a mobile communication device that recorded the first recorded position data and the second recorded position data.

3. The method of claim 2, wherein recording the first recorded position data and the second recorded position data comprised:
scanning, using a barcode scanner operatively coupled to the mobile communication device, one or more first barcodes associated with at least one of the one or more first items,
providing an indication that position data has been recorded for the first fixture, and
scanning, using the barcode scanner, one or more second barcodes associated with at least one of the one or more second items.

4. The method of claim 2, wherein recording the first recorded position data and the second recorded position data comprised:
recording, using a camera operatively coupled to the mobile communication device, one or more first identifiers associated with at least one of the one or more first items,
providing an indication that position data has been recorded for the first fixture, and
recording, using the camera, one or more second identifiers associated with at least one of the one or more second items.

5. The method of claim 1, further comprising:
receiving, at the remote computing device, a library of item data; and
storing the library of item data in a database accessible to the remote computing device,
wherein the first item data and the second item data is based on the library of item data.

6. The method of claim 5, further comprising:
receiving, at the mobile communication device, at least a subset of the library of item data prior to recording the first recorded position data and the second recorded position data.

7. The method of claim 1, further comprising:
receiving, at the remote computing device, a library of fixture data; and
storing the library of fixture data in a database accessible to the remote computing device,
wherein the fixture data is based on the library of fixture data.

8. The method of claim 7, further comprising:
receiving, at the mobile communication device, at least a subset of the library of fixture data prior to recording the first recorded position data and the second recorded position data.

9. The method of claim 1, further comprising:
receiving, at the remote computing device, a template planogram; and
storing the template planogram in a database accessible to the remote computing device,
wherein at least one of the first item data, the second item data, and the fixture data is based on data extracted from the template planogram.

10. The method of claim 1, wherein determining the first maximum item height comprises:
for each of the one or more first items:
determining an estimated item height for that item based on:
one or more of a height, a width, and a depth of that item; and
one or more of an item orientation, an item merchandise style, and an item stacking indicator for that item; and
selecting the largest estimated item height as the first maximum item height.

11. The method of claim 10, wherein at least one of the height, width, depth, item orientation, item merchandise style, and item stacking indicator for each of the one or more first items is based on data extracted from a template planogram stored in a database accessible to the remote computing device.

12. The method of claim 11, wherein a height component of the second position data is determined based on a height component of the first position data, the first maximum item height, and a predetermined finger space adjustment.

13. A system for generating a planogram data file, the system comprising:
a processor; and
a data store coupled to the processor,
wherein the processor is configured to:
receive first recorded position data for one or more first items located on a first fixture of a display segment, and second recorded position data for one or more second items located on a second fixture of the display segment;
generate a planogram data file, by:
writing first item data for the one or more first items and second item data for the one or more second items to the planogram data file;
writing fixture location data for the first fixture to the planogram data file;
writing, based on the first recorded position data, first position data for the one or more first items to the planogram data file;
determining, based on the first item data, a first maximum item height for the one or more first items;
writing, based on the first maximum item height, fixture location data for the second fixture to the planogram data file; and
writing, based on the second recorded position data, second position data for the one or more second items to the planogram data file.

14. The system of claim 13, wherein the first recorded position data and the second recorded position data is received from a mobile communication device that recorded the first recorded position data and the second recorded position data.

15. The system of claim 14, wherein recording the first recorded position data and the second recorded position data comprised:
scanning, using a barcode scanner operatively coupled to the mobile communication device, one or more first barcodes associated with at least one of the one or more first items,
providing an indication that position data has been recorded for the first fixture, and
scanning, using the barcode scanner, one or more second barcodes associated with at least one of the one or more second items.

16. The system of claim 14, wherein recording the first recorded position data and the second recorded position data comprised:
recording, using a camera operatively coupled to the mobile communication device, one or more first identifiers associated with at least one of the one or more first items,
providing an indication that position data has been recorded for the first fixture, and
recording, using the camera, one or more second identifiers associated with at least one of the one or more second items.

17. The system of claim 13, wherein the first item data and the second item data is based on a library of item data stored in the data store.

18. The system of claim 13, wherein the fixture data is based on a library of fixture data stored in the data store.

19. The system of claim 13, wherein at least one of the first item data, the second item data, and the fixture data is based on data extracted from a template planogram stored in the data store.

20. The system of claim 13, wherein the processor is configured to determine the first maximum item height by:
for each of the one or more first items:
determining an estimated item height for that item based on:
one or more of a height, a width, and a depth of that item; and
one or more of an item orientation, an item merchandise style, and an item stacking indicator for that item; and
selecting the largest estimated item height as the first maximum item height.

21. The system of claim 20, wherein at least one of the height, width, depth, item orientation, item merchandise style, and item stacking indicator for each of the one or more first items is based on data extracted from a template planogram stored in the data store.

22. The system of claim 21, wherein the processor is configured to determine a height component of the second position data based on a height component of the first position data, the first maximum item height, and a predetermined finger space adjustment.

23. A computer-readable medium storing computer-executable instructions, the instructions for causing a processor to perform a method for generating a planogram data file, the method comprising:
receiving first recorded position data for one or more first items located on a first fixture of a display segment, and second recorded position data for one or more second items located on a second fixture of the display segment;
generating a planogram data file, by:
writing first item data for the one or more first items and second item data for the one or more second items to the planogram data file;
writing fixture location data for the first fixture to the planogram data file;
writing, based on the first recorded position data, first position data for the one or more first items to the planogram data file;
determining, based on the first item data, a first maximum item height for the one or more first items;
writing, based on the first maximum item height, fixture location data for the second fixture to the planogram data file; and
writing, based on the second recorded position data, second position data for the one or more second items to the planogram data file.

24. The computer-readable medium of claim 23, wherein the first item data and the second item data is based on a library of item data stored in a database accessible to the processor.

25. The computer-readable medium of claim 23, wherein the fixture data is based on a library of fixture data stored in a database accessible to the processor.

26. The computer-readable medium of claim 23, wherein at least one of the first item data, the second item data, and the fixture data is based on data extracted from a template planogram stored in a database accessible to the processor.

27. The computer-readable medium of claim 23, wherein determining the first maximum item height comprises:
for each of the one or more first items:
determining an estimated item height for that item based on:
one or more of a height, a width, and a depth of that item; and
one or more of an item orientation, an item merchandise style, and an item stacking indicator for that item; and
selecting the largest estimated item height as the first maximum item height.

28. The computer-readable medium of claim 27, wherein at least one of the height, width, depth, item orientation, item merchandise style, and item stacking indicator for each of the one or more first items is based on data extracted from a template planogram stored in a database accessible to the processor.

29. The computer-readable medium of claim 28, wherein a height component of the second position data is determined based on a height component of the first position data, the first maximum item height, and a predetermined finger space adjustment.
